(19) United States
(12) Patent Application Publication
(10) Pub. No.: US 2011/0204112 A1
(43) Pub. Date: Aug. 25, 2011

(54) Wrap-Around Carrying Case For Selectively Displaying An Electronic Device

(75) Inventors: Kevin Duane Crandall, Santa Rosa, CA (US); Darren S. Hulsey, Santa Rosa, CA (US); Greame David Esarey, Seattle, WA (US)

(73) Assignee: DayMen Photo Marketing LP, Markham (CA)

(21) Appl. No.: 12/709,368

(22) Filed: Feb. 19, 2010

(51) Int. Cl. B60R 11/00; B65D 85/00

(52) U.S. Cl. 224/572; 206/320

(57) ABSTRACT

Embodiments hereof relate to an electronic device carrying case that selectively alternates between a display configuration that displays a portable electronic device such as a GPS receiver below the dash level of a vehicle and a transport configuration that wraps around the electronic device. The carrying case includes a storage compartment for removably receiving the electronic device and a relatively planar panel having a first end coupled to the storage compartment and a weighted second end. In the display configuration, the weighted second end lies flat against the dash of a vehicle to secure the carrying case thereto, and the panel is sufficiently long such that the electronic device is displayed below the dash level. In the transport configuration, the panel wraps around and encircles the electronic device.

### FIELD OF THE INVENTION

The invention is related to an apparatus and method for securing and displaying an electronic device such as a global positioning system (GPS) receiver.

### BACKGROUND OF THE INVENTION

Many types of devices exist for mounting or displaying a portable GPS receiver within a vehicle. For example, mounts can be placed on a dash or on a windshield. However, such mounts place the GPS receiver directly within the windshield line of sight and may interfere with an operator's ability to see the road and operate the vehicle safely. Further, some states restrict the type the use of certain types of mounts, including windshield suction cup mounts. It is an object hereof to provide a device that displays a GPS receiver or other device below the dash level of a vehicle such that the GPS receiver does not obstruct the view of the driver and satisfies any relevant laws or regulations.

In addition, it is an object hereof to provide a device that may convert between a display configuration that displays the GPS receiver below the dash level of a vehicle to a transport configuration that safely covers and secures the electronic device received therein. When travelling out of town, or simply relocating a GPS receiver from one place to another, it is desirable to protect the GPS receiver's internal circuitry and delicate componentry if the electronic device is inadvertently dropped or impacted.

### BRIEF SUMMARY OF THE INVENTION

Embodiments hereof relate to an electronic device carrying case for mounting an electronic device within a vehicle. The carrying case includes a storage compartment operable to removably secure an electronic device therein and a substantially planar panel having a first end coupled to the storage compartment and a weighted second end. The second end of the panel is operable to lay flat against a top surface of a dash of a vehicle to secure the carrying case thereto such that the storage compartment hangs from the panel to display the electronic device below the dash of the vehicle.

Embodiments hereof relate to an electronic device carrying case for mounting an electronic device to a generally horizontal surface. The carrying case includes a storage compartment operable to removably secure an electronic device therein and a substantially planar panel having a first end coupled to the storage compartment and a weighted second end. The second end of the panel is operable to lay flat against the generally horizontal surface to secure the carrying case thereto such that the storage compartment hangs from the panel to display the electronic device generally orthogonal to and below the horizontal surface.

The carrying case may selectively alternate between a transport configuration in which the panel wraps around to encircle the storage compartment, and a display configuration in which the panel is operable to lay flat against a top surface of a dash of a vehicle or other horizontal surface to secure the carrying case thereto such that the storage compartment hangs from the panel to display the electronic device below the dash of the vehicle or horizontal surface.

### BRIEF DESCRIPTION OF DRAWINGS

The foregoing and other features and advantages of the invention will be apparent from the following description of the invention as illustrated in the accompanying drawings. The accompanying drawings, which are incorporated herein and form a part of the specification, further serve to explain the principles of the invention and to enable a person skilled in the pertinent art to make and use the invention. The drawings are not to scale.

FIG. 1 is a top view illustration of an electronic device carrying case according to an embodiment hereof.

FIG. 1A is a cross-sectional view of the electronic device carrying case of FIG. 1 taken along line A-A of FIG. 1 according to an embodiment hereof.

FIG. 1B is a cross-sectional view of the electronic device carrying case of FIG. 1 taken along line A-A of FIG. 1 according to an alternative embodiment hereof.

FIG. 2 is a top view illustration of an electronic device in the process of being inserted into the electronic device carrying case of FIG. 1.

FIG. 3 is a perspective view illustration of the electronic device carrying case of FIG. 1 having an electronic device inserted therein.

FIG. 4 is an illustration of the electronic device carrying case of FIG. 1 displaying an electronic device below the dash of a vehicle.

FIG. 5 is a bottom view illustration of the electronic device carrying case of FIG. 1.

FIGS. 6-10 illustrate a method of securely wrapping an electronic device within the electronic carrying case of FIG. 1.

FIG. 11 is a perspective view of an electronic device carrying case according to another embodiment hereof.

### DETAILED DESCRIPTION OF THE INVENTION

Specific embodiments of the present invention are now described with reference to the figures, wherein like reference numbers indicate identical or functionally similar elements. The following detailed description is merely exemplary in nature and is not intended to limit the invention or the application and uses of the invention. Although the description of the invention is in the context of securing electronic devices, the invention may also be used to secure other devices as it is deemed useful. Furthermore, there is no intention to be bound by any expressed or implied theory presented in the preceding technical field, background, brief summary or the following detailed description.

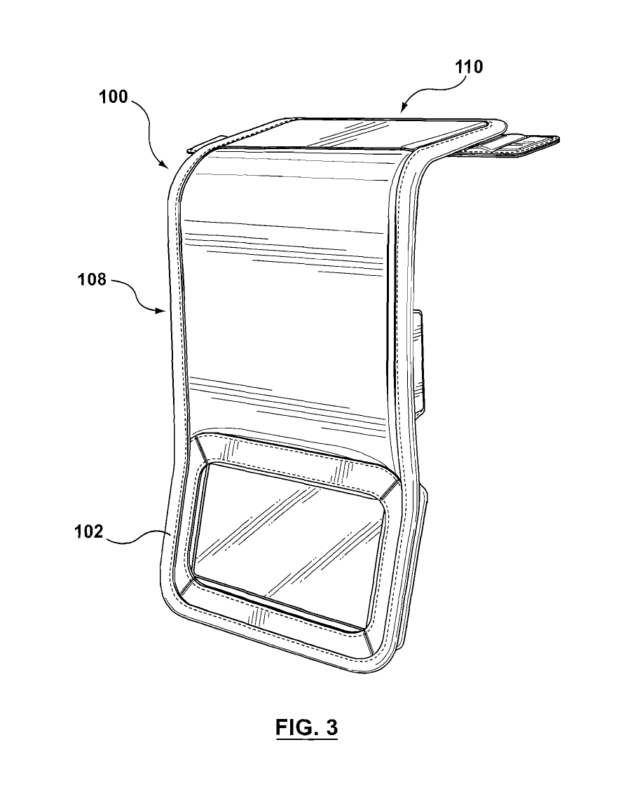

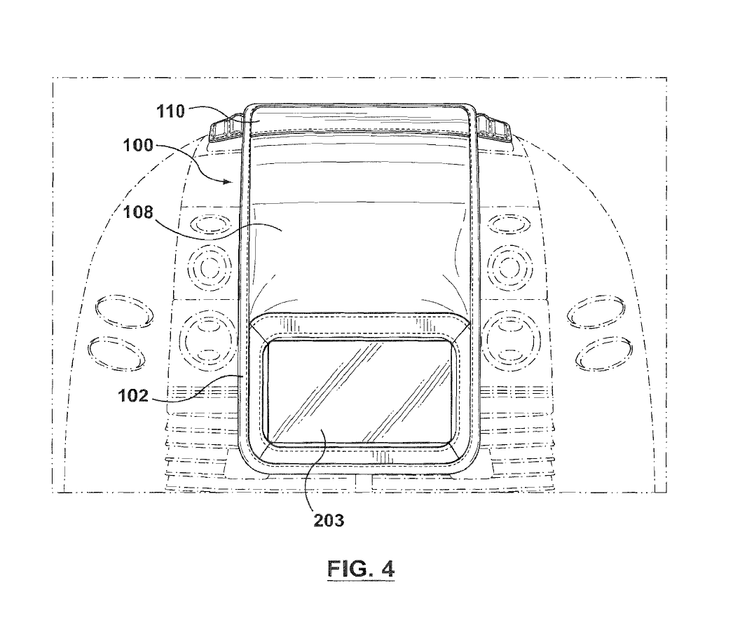

Embodiments hereof relate to an electronic device carrying case 100 for displaying or mounting an electronic device such as a portable GPS receiver or other electronic device within a vehicle. Electronic device carrying case 100 selectively alternates between a display configuration that displays the GPS receiver below the dash level of a vehicle (shown in FIGS. 3-4) and a transport configuration that wraps around and protects the GPS receiver from breakage or damage (shown in FIGS. 9-10). Although described herein for displaying or protecting a GPS receiver, it will be apparent to one of ordinary skill in the art that carrying case 100 may be utilized to display and/or safely store any type of electronic device including for example a camera, a mobile phone, a personal digital assistant (PDA), a tablet computer, a MP3 player, or other handheld portable electronic device. Further, although the embodiments are described herein for using the carrying case to mounting a device to a dash of a vehicle, it will be apparent to one of ordinary skill in the art that the carrying case could be used to mount the device to any generally horizontal surface.

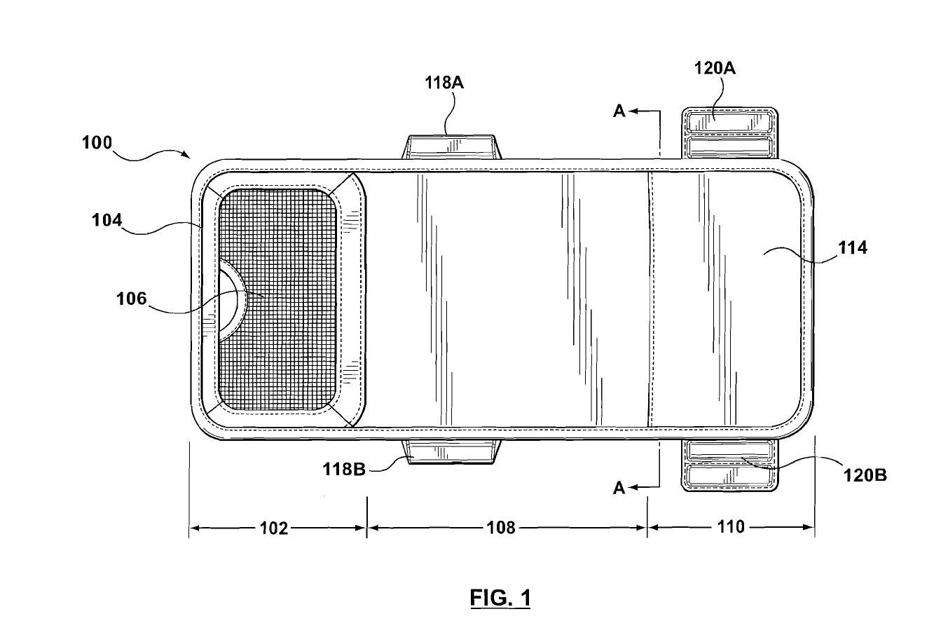

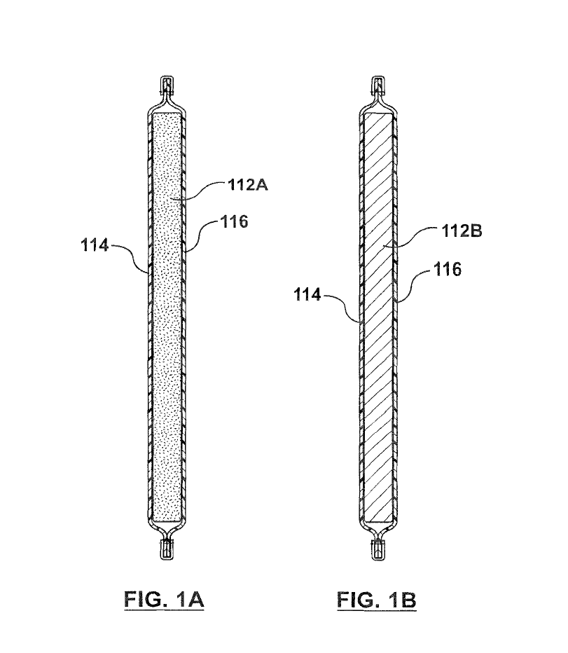

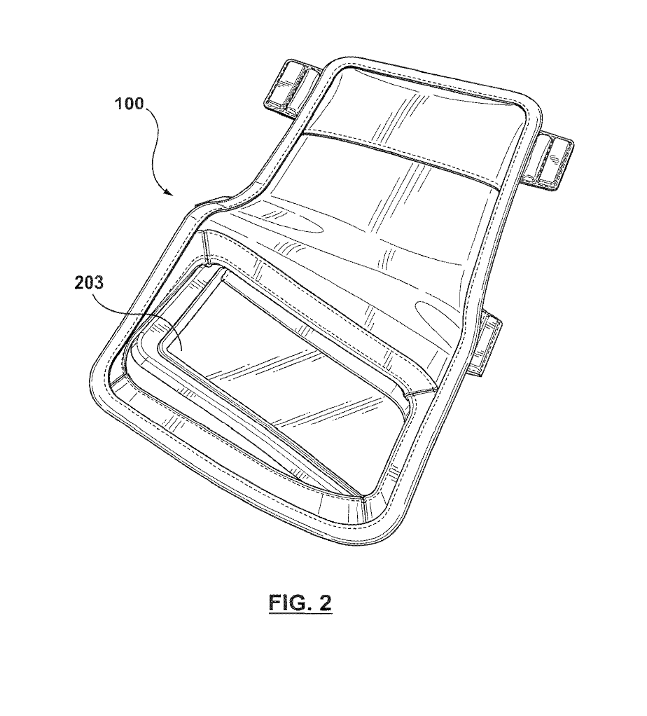

Referring to FIGS. 1-4, electronic device carrying case 100 will first be described in its display configuration. FIG. 1 is a top view illustration of electronic device carrying case 100 according to an embodiment hereof. In the embodiment of FIG. 1, electronic device carrying case 100 includes three integral or continuous sections or panels: an electronic device storage compartment or holding device 102, an intermediate panel or section 108, and an end panel or section 110. It would be understood by those of ordinary skill in the art that intermediate panel 108 and end panel 110 may be considered a single panel and are described herein as a an intermediate panel and an end panel merely for convenience. In other words, intermediate panel 108 and end panel 110 may simply be considered sections of a single panel. Further, storage compartment 102 may also be considered a section of a single panel, as described herein. Electronic device storage compartment 102 functions to receive a portable electronic device 203, as shown in FIG. 2 which illustrates a GPS receiver being inserted electronic device carrying case 100. In an embodiment shown in FIG. 1, electronic device storage compartment 102 includes a back panel or backing 106 and a border 104 sized to securely fit and/or stretch around the edges of electronic device 203 as shown in FIG. 2. Backing 106 and border 104 define a volume suitable to contain electronic device 203 within storage compartment 102. When electronic device 203 is secured within storage compartment 102, border 104 does not obstruct full access and visibility to the front panel of electronic device 203.

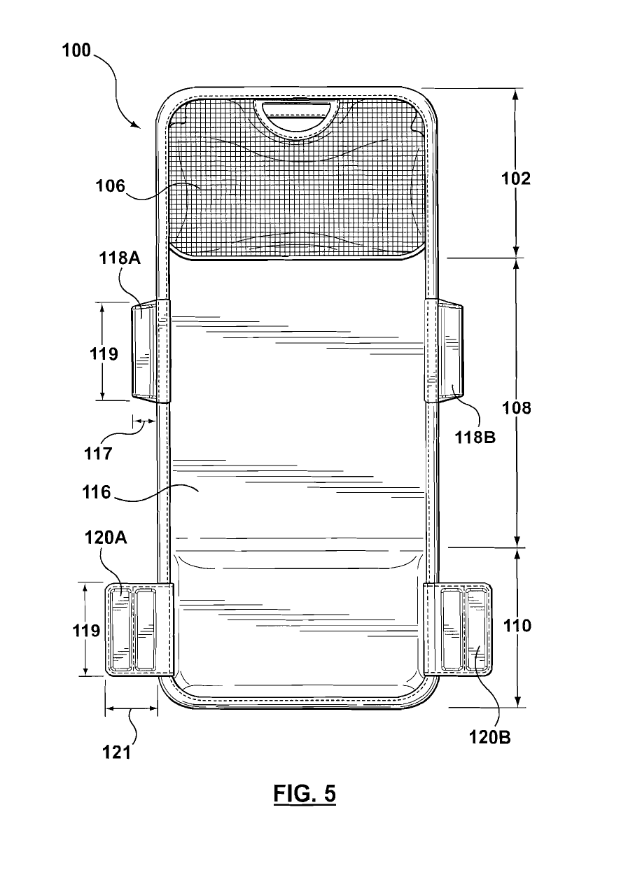

Intermediate panel 108 and end panel 110 are made from relatively flexible materials such that they may wrap around storage compartment 102, as described in more detail below. As best shown in the perspective view of FIG. 3, end panel 110 is a relatively planar or flat structure. End panel 110 contains a weighted material therein. In the embodiment shown, the weighted material is sandwiched between two layers of material, a top or outer cover 114 and a bottom layer or backing 116, as shown in FIG. 1A which is a cross-sectional view taken along line A-A of FIG. 1. In the embodiment shown in FIG. 1A, weighted material 112A is sand. In an alternative embodiment shown in FIG. 1B, weighted material 112B is a plurality of metal rods or plates. It would be understood by those of ordinary skill in the art that the weighted material may be any suitable material to counter the weight of the electronic device 203 when case 100 is in the display configuration. In an embodiment, the weighted material weighs approximately 175 grams. However, the weighted material may be any suitable weight depending on the size and weight contemplated for electronic device 203. Top or outer cover 114 is a stretchy, protective material such as canvas, cloth, synthetic leather, leather, or tarpaulin. Backing 116, which is best shown in the bottom view illustration of FIG. 5, is a tacky or nonslip material that tends to cling to a surface in a mechanical fashion. Suitable tacky or nonslip materials include an expanded vinyl material such as diisodecy/phlthalate, polymeric plasticer, a UV stabilizer, a vinyl hear stabilizer, a blowing agent for vinyl plastisol, or vinyl resin (plastic). When electronic device carrying case 100 is in the display configuration, end panel 110 functions as a weighted base that mounts electronic device carrying case 100 to a top surface of the vehicle dash, as shown in FIG. 4. The nonslip material of backing 116, in combination with the weighted material located within end panel 110, secures electronic device carrying case 100 to a top surface of the vehicle dash such that carrying case 100 does not move or slip while the vehicle is in operation. End panel 110 may have a length approximately equal to or slightly greater the length of storage compartment 102 such that end panel 110 covers the front panel of electronic device 203 when carrying case 100 is in the transport configuration, as will be described in more detail herein. In an embodiment, intermediate panel 108 and end panel 110 have a combined length of approximately 26.5 centimeters such that they may wrap around electronic device 203, as described below. However, it would be understood by those of ordinary skill in the art that any length suitable to mount carrying case 100 to a dash as described below, depending on the contemplated size of electronic device 203, may be used. Further, any suitable length for panels 108/110 to wrap around electronic device may be used.

Intermediate panel 108 is a relatively planar or flat structure that integrally extends between storage compartment 102 and end panel 110, as best shown in the perspective view of FIG. 3. Intermediate panel 108 may have a length that functions to display the electronic device such as a GPS receiver below the dash of a vehicle, as shown in FIG. 4. By displaying GPS receiver 203 below the dash level of a vehicle, GPS receiver 203 does not obstruct the view of the driver and satisfies any relevant laws or regulations that may restrict mounting a GPS receiver or other device on a windshield, above dash level, or otherwise possibly restricting the view of the operator. Intermediate panel 108 may have a length equal to or slightly greater than the length of storage compartment 102 such that intermediate panel 108 wraps around electronic device 203 when carrying case 100 is in the transport configuration, as will be described in more detail herein.

According to an embodiment hereof, intermediate panel 108 has two layers of material similar to end panel 110, top cover 114 which is a stretchy, protective material such as canvas, cloth, synthetic leather, leather, or tarpaulin and backing 116 which is a tacky or nonslip material. Thus, the nonslip material of backing 116 may extend along the entire length of panels 108, 110 as shown in the bottom view of FIG. 5 in order to further secure electronic device carrying case 100 to adjacent surfaces of the vehicle. In another embodiment hereof (not shown), intermediate panel 108 may include only one layer of material such as the stretchy, protective material of top cover 114, and does not include the tacky or nonslip backing 116.

In the embodiment shown in FIGS. 1-10, intermediate panel 108 includes two tabs or extensions 118A, 118B extending from opposing edges thereof, and end panel 110 includes two tabs or extensions 120A, 120B extending from opposing edges thereof. Tabs 118A, 118B, 120A, 120B may be stitched or otherwise mechanically secured to the edges of panels 108, 110, respectively. Tabs 118A, 118B, 120A, 120B each contain a magnet (not shown) therein that assist in maintaining the carrying case in its transport configuration, as will be described in more detail herein with respect to FIGS. 5-10. In the embodiment shown, tabs 118A, 118B, 120A, 120B all have approximately the same length 119, but the width 121 of tabs 120A, 120B are is approximately twice the width 117 of tabs 118A, 118B because tabs 120A, 120B essentially fold over tabs 118A, 118B when carrying case 100 is in the transport configuration, as will be described in more detail herein. As would be apparent to one of ordinary skill in the art, the size of the tabs may vary.

Referring now to FIGS. 5-10, a method of converting electronic device carrying case 100 from its display configuration to its transport configuration is described. FIG. 5 is a bottom view of electronic carrying case 100, exposing backings 106, 116 of storage compartment 102 and panels 108, 110, respectively. Although obscured in FIG. 5 due to backing 106, electronic device 203 is secured within storage compartment 102 as described above with respect to the display configuration of carrying case 100. Electronic device 203 thus faces in a downward direction in FIG. 5.

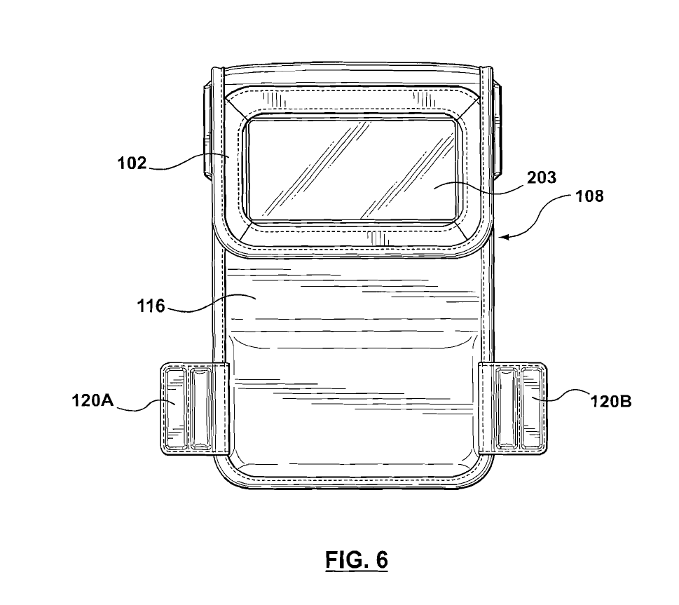

In the transport configuration of carrying case 100, panels 108 and 110 of carrying case 100 wrap around electronic device 203. The first step of transforming carrying case 100 to the transport configuration is shown in FIG. 6, in which storage compartment 102 (having electronic device 203 secured therein) is flipped or turned over such that backing 106 of storage compartment 102 rests against backing 116 of intermediate panel 108. The front panel of electronic device 203 is now facing in an upwards direction. In FIG. 6, tabs 118A, 118B are obscured from view because they are extending upwards from the edges of intermediate panel 108 to rest against storage compartment 102.

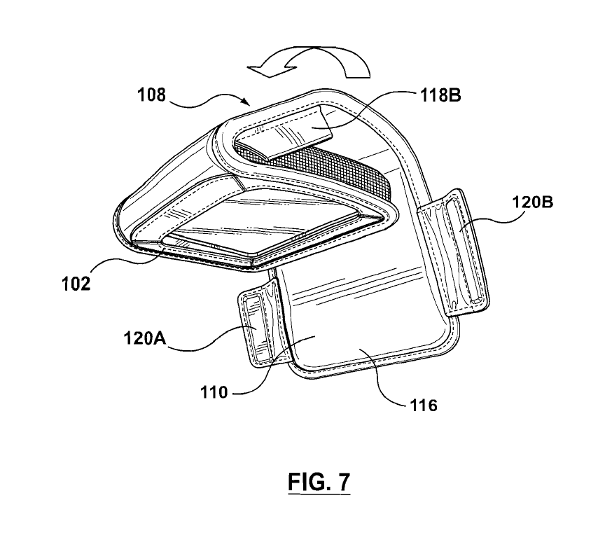

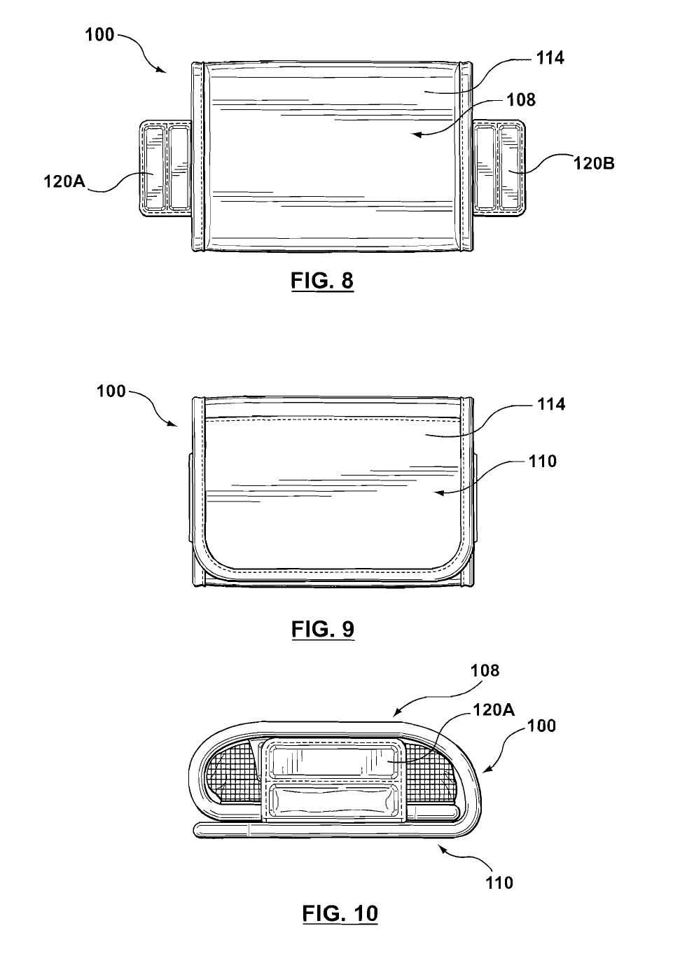

Next, storage compartment 102 (having electronic device 203 secured therein) and intermediate panel 108 are collectively flipped or turned over as shown in FIG. 7 until the front panel of electronic device 203 rests against backing 116 of end panel 110 as shown in FIG. 8. FIG. 8 thus illustrates electronic device 203 being securely wrapped or encircled within panels 108, 110 of carrying case 100. Intermediate panel 108 covers and protects the back panel of electronic device 203, and end panel 110 covers and protects the front panel of electronic device 203. In FIG. 8, tabs 120A, 120B which extend from end panel 110 are pinned down flat.

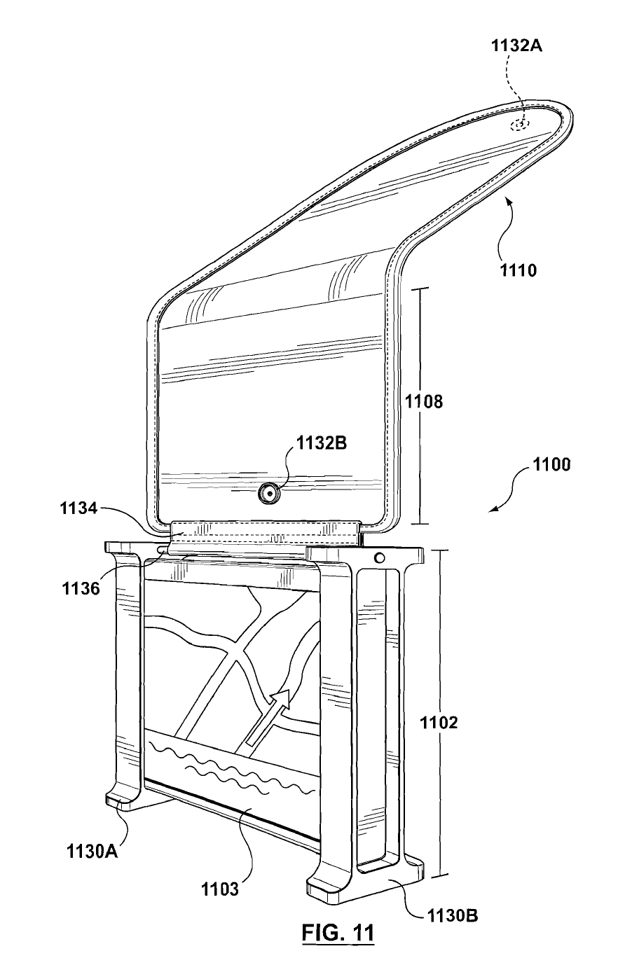

FIGS. 9-10 illustrate carrying case 100 in its transport configuration. More particularly, tabs 120A, 120B are released from the pinned down position of FIG. 8 and operate to close carrying case 100. The magnets within tabs 120A, 120B are magnetically attracted to the magnets within tabs 118A, 118B, respectively, and tabs 120A, 120B essentially fold over tabs 118A, 118B. Thus, tabs 118A, 120A are magnetically coupled together on one side of the carrying case and tabs 118B, 120B are magnetically coupled together on the opposing side of the carrying case to effectively seal the sides of carrying case 100 as best shown in FIG. 10. Sealing the sides of carrying case 100 prevents panels 108, 110 from unintentionally unwrapping or unfolding, and secures electronic device 203 located within storage compartment 102 within carrying case 100 for transport. When it is desired to display electronic device 203, tabs 118A, 120A and tabs 118B, 120B are uncoupled by pulling the respective magnets apart and carrying case 100 may simply be unravel into the display configuration of FIGS. 3-4. As would be understood by one of ordinary skill in the art, other connecting mechanisms may be used to couple tabs 118A, 118B to tabs 120A, 120B, respectively. For example, and not by way of limitation, hook and loop fasteners (such as VELCRO) may be used, wherein tabs 118A, 118B include hooks and tabs 120A, 120B includes loops (or vice versa). Further, it would be understood by one of ordinary skill in the art that tabs 118A, 118B, 120A, 120B are not necessary. Instead, other closure mechanisms for securing panels 108, 110 around electronic device 203 may be utilized, such as those described below with respect to the embodiment shown in FIG. 11.

Although the above description states that tabs 120A, 120B are released from the pinned down position of FIG. 8 to close carrying case 100, it should be understood to those of ordinary skill in the art that active release is not required. Rather, tabs 120A, 120B are pinned down flat in FIG. 8 for illustrative purposes only. In operation, once electronic device 203 is wrapped or encircled within panels 108, 110 of carrying case 100, the magnets of the tabs are drawn together by their own attractive forces and automatically couple tabs 118A, 120A and tabs 118B, 120B. Accordingly, for a user to transform carrying case 100 into the transport configuration, only the flipping/turning steps described with respect to FIGS. 6 and 7 require user action. Essentially, electronic device 203 secured within storage compartment 102 is simply wrapped up to be encircled by panels 108, 110 by the user and the magnets of tabs 118A, 120A, 118B, 120B self-close carrying case 100 into the transport configuration.

FIG. 11 is a perspective view of an electronic device carrying case according to another embodiment hereof. In FIG. 11, electronic device carrying case 1100 is shown in its display configuration. Similar to the embodiment of FIG. 1, electronic device carrying case 1100 includes three sections or panels, an electronic device storage compartment 1102, an intermediate panel or section 1108, and an end panel or section 1110. Electronic device storage compartment 1102 functions to receive a portable GPS receiver 1103. Further, panels 1108, 1110 are continuous, integral relatively planar or flat structures similar to panels 108, 110 described above. Panels 1108, 1110 operate to mount electronic device 1103 below the dash of a vehicle when carrying case 1100 is in a display configuration, and operate to wrap around or encircle electronic device 1103 when carrying case 1100 is in a transport configuration. Panels 1108 and 1110 may be similar to panels 108 and 110 described above with respect to the embodiment of FIGS. 1-10. For example, end panel 1110 includes a weighted material and a back panel that is tacky or non-slip. Other features described above with respect to FIGS. 1-10 may also be used in conjunction with the embodiment of FIG. 11, and vice versa.

In the embodiment of FIG. 11, electronic device storage compartment 1102 is defined by two loops 1130A, 1130B for receiving opposing edges of electronic device 1103. Loops 1130A, 1130B are preferably formed from an elastomeric material and are stretched slightly to capture and secure the edges of electronic device 1103 using friction/compression. When electronic device 1103 is secured within storage compartment 1102, loops 1130A, 1130B do not obstruct full access and visibility to the front panel of electronic device 1103. Loops 1130A, 1130B are coupled to each other using a rod or post 1136. Intermediate panel 1108 includes an extension 1134 looped around rod 1136 to coupled intermediate panel 1108 to rod 1136. Extension 1134 may be an integral part of panel 1108 or may be sewn or otherwise attached thereto. By looping extension 1134 around rod 1136, panels 1108/1110 are free to wrap around electronic device 1103. Thus, as shown, the storage compartment of carrying cases according to the present invention may have various configurations as long as a portable electronic device may be removably secured therein.

In addition, the carrying case according to the present invention may also have various configurations for effecting closure thereof when in the transport configuration. For example, in the embodiment of FIG. 11, carrying case 1100 includes a closure mechanism at the end of panel 1110 to close carrying case 1100 as opposed to tabs 118A, 118B, 120A, 120B described in respect to FIGS. 1-10. In the embodiment of FIG. 11, the closure mechanism is a snap for securing carrying case 1100 in the transport configuration. More particularly, a female component 1132B of the snap is attached to the top cover of intermediate panel 1108 and a mating male component 1132A of the snap is attached to the backing of end panel 1110 (shown in phantom in FIG. 11 for illustrative purposes). When panels 1108, 1110 are wrapped to encircle electronic device 1103, the female and male components 1132B, 1132A of the snap are aligned and coupled or snapped together. Although described as having a female component attached to intermediate panel 1108 and a mating male component attached to end panel 1110, it will be understood by those of ordinary skill in the art that the female component may be attached to end panel 1110 and the mating male component may be attached to intermediate panel 1108. In addition, although closure mechanism is described as a snap, it will be apparent to those of ordinary skill in the art that various closure devices may be utilized for effecting closure of carrying case 1100. For example, the closure mechanism may be a button, a hook and loop fastener, magnetic attraction, or other releasable mechanical closing structure.

While various embodiments according to the present invention have been described above, it should be understood that they have been presented by way of illustration and example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the appended claims and their equivalents. It will also be understood that each feature of each embodiment discussed herein, and of each reference cited herein, can be used in combination with the features of any other embodiment. All patents and publications discussed herein are incorporated by reference herein in their entirety.

What is claimed is:

1. An electronic device carrying case comprising:
a storage compartment operable to removably secure an electronic device therein; and
a substantially planar panel having a first end coupled to the storage compartment;
wherein the carrying case includes a display configuration wherein the panel is operable to lay flat against a top surface of a dash of a vehicle to secure the carrying case thereto such that the storage compartment hangs from the panel to display the electronic device received within the storage compartment below the dash of the vehicle.

2. The carrying case of claim 1, wherein the storage compartment includes a backing and a border configured to stretch around edges of the electronic device such that the border does not obstruct access and visibility to a front panel of the electronic device.

3. The carrying case of claim 1, wherein the storage compartment includes two loops configured to secure opposing edges of the electronic device via friction and compression, and a connector coupling the loops to each other.

4. The carrying case of claim 1, wherein a second end of the panel opposite the first end includes a weighted material.

5. The carrying case of claim 4, wherein the weighted material of the end panel is sandwiched between a layer of protective material and a layer of nonslip material.

6. The carrying case of claim 5, wherein the weighted material is sand.

7. The carrying case of claim 5, wherein the weighted material is at least one steel bar.

8. The carrying case of claim 1, wherein at least one surface of the panel includes a layer of nonslip material.

9. The carrying case of claim 1, wherein the carrying case selectively alternates between the display configuration and a transport configuration wherein the panel wraps around to encircle the storage compartment.

10. The carrying case of claim 10, wherein the panel includes an end section and an intermediate section disposed between the end section and the storage compartment, wherein the intermediate section includes a first tab and a second tab extending from opposing edges thereof and the end section includes a third tab and a fourth tab extending from opposing edges thereof, and wherein in the transport configuration, the first tab is coupled to the third tab and the second tab is coupled to the fourth tab to close the carrying case.

11. The carrying case of claim 10, wherein a snap is utilized to close the carrying case in the transport configuration.

12. An electronic device carrying case for mounting an electronic device within a vehicle, the carrying case comprising:
a storage compartment operable to removably secure an electronic device therein; and
a substantially planar panel having a first end coupled to the storage compartment and a second end disposed opposite the first end;
wherein the panel includes a weighted material disposed at the second end and a layer of non-slip material.

13. The carrying case of claim 12, wherein the storage compartment includes a backing and a border configured to stretch around edges of the electronic device such that the border does not obstruct access and visibility to a front panel of the electronic device.

14. The carrying case of claim 12, wherein the storage compartment includes two loops configured to secure opposing edges of the electronic device via friction and compression, and a connector coupling the loops to each other.

15. The carrying case of claim 12, wherein the weighted material is sandwiched between a layer of protective material and the layer of nonslip material.

16. The carrying case of claim 12, wherein the weighted material is sand.

17. The carrying case of claim 12, wherein the weighted material is at least one steel bar.

18. The carrying case of claim 12, wherein the intermediate panel has a first layer of protective material and a second layer of nonslip material.

19. The carrying case of claim 12, wherein the panel is sufficiently long and pliable such that the panel is configured to wrap around to encircle the storage compartment in a transport configuration.

20. The carrying case of claim 19, further comprising a closure element to secure the panel in the transport configuration.
